(19) United States
(12) Patent Application Publication
(10) Pub. No.: US 2009/0160364 A1
(43) Pub. Date: Jun. 25, 2009

(54) OPERATING SOLID-STATE LIGHTING ELEMENTS

(75) Inventors: Bernd Ackermann, Aachen (DE); Dirk Hente, Würselen (DE); Christoph Martiny, Aachen (DE); Georg Sauerländer, Aachen (DE); Matthias Wendt, Würselen (DE)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/296,080

(22) PCT Filed: Mar. 27, 2007
(86) PCT No.: PCT/IB2007/051090

§ 371 Date: Oct. 3, 2008

(30) Foreign Application Priority Data
Apr. 12, 2006 (EP) 06112549.8

(51) Int. Cl. H05B 37/02

(52) U.S. Cl. 315/294

(57) ABSTRACT

Operating a lighting device by acquiring a target brightness level of at least one solid-state lighting unit, and determining a reference driving current amplitude for obtaining the target brightness level. If the reference driving current amplitude is below an optimum driving current amplitude, the solid-state lighting unit is operated at the optimum driving current amplitude, which is pulse-width modulated to obtain the target brightness level.

### FIELD OF THE INVENTION

The present invention relates in general to solid-state lighting and methods of operating solid-state lighting units.

### BACKGROUND OF THE INVENTION

Solid-state lighting has become an important feature in the illumination market. Solid-state lighting (SSL) units, such as light-emitting diodes (LED), and organic light-emitting diodes (OLED), provide lighting at low cost, and are therefore intended for the general illumination market. The solid-state light sources provide light at certain wavelengths. The wavelengths are dependent on the materials used, i.e. semiconductors, and environmental properties of the SSL units. Furthermore, the solid-state light sources may have a high luminous efficacy, but this is also a function of temperature and driving method.

In current lighting applications, the lumen output of the solid-state light sources is desired to be at a maximum. The solid-state light sources are therefore driven with a current at the maximally allowable amplitude. This may be accompanied by thermal constraints. However, driving the solid-state light sources with the maximal driving current does not result in an efficient lumen output, i.e. the luminous efficacy may be higher at lower driving currents.

There are also applications in which the solid-state light sources need to be dimmed. This may be the case in ambient lighting. Moreover, when using the solid-state light sources in colored lamps, in which more than one wavelength is required, such as RGB LED lamps, the brightness of each lamp as well as the overall brightness needs to be adjusted.

Methods of modulating the driving current by using amplitude modulation (AM), pulse-width modulation (PWM), or pulse-frequency modulation (PFM) are known in the art. Further modulation methods are also known in the art. DE 198 48 925 A1 discloses a method which allows adjustment of the driving current of solid-state lighting units by pulse-width modulation. This document shows that brightness may be reduced by means of pulse-width modulation, in which the driving current has an amplitude which is equal to or higher than a threshold value. However, this leads to dimming of the solid-state light sources without accounting for their luminous efficacy and efficiency.

### OBJECT AND SUMMARY OF THE INVENTION

It is an object of the present invention to realize efficient use of solid-state light sources. It is a further object of the present invention to ensure an increased luminous efficacy and efficiency, while dimming the brightness level of solid-state light sources. It is another object of the present invention to provide optimum luminous efficacy and efficiency at a given brightness level, and driving the solid-state lighting unit with the reference driving current amplitude when the reference driving current amplitude is larger than the optimum driving current amplitude.

These and other objects are solved by a method of operating a lighting device, the method comprising the steps of acquiring a target brightness level of at least one solid-state lighting unit, determining a reference driving current amplitude for obtaining the target brightness level, and driving the solid-state lighting unit with a pulse-width modulated optimum driving current amplitude when the reference driving current amplitude is smaller than or equal to the optimum driving current amplitude to obtain the target brightness level.

It has been found that, whilst lumen output is largest at the maximally allowable current amplitude, the luminous efficacy and efficiency are larger at smaller current amplitudes. An optimum driving current amplitude may be obtained by evaluating operational data of the solid-state lighting units, such as the relative luminous flux and electric input power curves of the data sheets. It has further been found that a target brightness level may be obtained by driving a solid-state lighting unit with an optimum driving current amplitude and by pulse-width modulating this optimum driving current amplitude. This accounts for obtaining the maximum efficiency of the solid-state lighting unit.

According to the present invention, the intensity of solid-state lighting units, such as LEDs used in LED lamps, as well as the intensity of a plurality of LEDs, can be manipulated, while still providing a high efficiency. Changing the color and increasing the brightness difference between LEDs of the same color can be controlled, while maintaining a high efficiency.

The reference driving current amplitude may be determined by obtaining the current amplitude, which will be necessary to run the solid-state lighting unit at the target brightness level. The reference driving current amplitude may be obtained by using the data sheet provided with the solid-state lighting unit. This data sheet may provide information about the relation between the input power and the luminous flux. On-line measurement of the brightness level and driving current, and thus obtaining the reference driving current amplitude, is also possible.

The current amplitude may be understood to be the current value at which the light source is driven. It may be the surge, time-averaged, or effective value or the difference between the minimum and maximum current.

After its determination, the reference driving current amplitude may be compared with the optimum driving current amplitude. This optimum driving current amplitude may be obtained by calculating the relation between the luminous flux and the input power. A local maximum of this relation function may be considered as being the optimum driving current amplitude. At this driving current amplitude, the efficiency, which is the ratio between the luminous flux and the input power, is highest.

If the reference driving current is smaller than or equal to the optimum driving current, the present invention ensures that the solid-state lighting unit is driven with the optimum driving current amplitude, which is pulse-width modulated. The optimum driving current amplitude, if applied to the solid-state lighting unit without any further modulation, will thus provide a brightness level which is higher than the target brightness level. Nevertheless, the optimum driving current amplitude provides the maximum efficiency for the solid-state lighting unit. To obtain the target brightness level, it is proposed to pulse-width modulate the optimum driving current amplitude. This pulse-width modulation accounts for dimming the brightness level until the target brightness level is obtained.

Determination of the optimum driving current amplitude as defined in claim 2 is preferred. An efficiency function relative to the input current, or input voltage, may be obtained by calculating the relation between the luminous flux and the input power, i.e. the input current, the input voltage, or the product of input current and input voltage. This efficiency function may have a local maximum. The position at which the local maximum is reached determines the optimum driving current amplitude.

A method as defined in claim 3 is therefore further preferred.

In accordance with a method as defined in claim 4, the maximum efficiency of the solid-state lighting unit may be a function of material properties and ambient properties of the solid-state lighting unit. For instance, different semiconductors used in the solid-state lighting unit may account for different efficiency curves. Moreover, temperatures may influence the efficiency curve and bias its maximum, and may thus change the optimum driving current amplitude.

The target brightness level may not be obtained with a driving current which is equal to or smaller than the optimum driving current amplitude. In that case, a method as defined in claim 5 is preferred. If the target brightness level can only be reached with a driving current which is higher than the optimum driving current amplitude, the solid-state lighting unit is driven with the reference driving current amplitude so as to obtain the target brightness level.

Driving the solid-state lighting unit with amplitude modulation is preferred. As defined in claim 6, it is at least preferred to drive the solid-state lighting unit with an amplitude-modulated driving current when the reference driving current amplitude is larger than the optimum driving current amplitude.

If the reference driving current amplitude is below the optimum driving current amplitude, pulse-width modulation is applied to the optimum driving current amplitude for driving the solid-state lighting unit. The duty cycle of the pulse-width modulated optimum driving current amplitude may be determined as defined in claim 7. The further the reference driving current is below the optimum driving current amplitude, the shorter the duty cycles.

Driving the solid-state lighting unit by means of a circuit as defined in claim 8 is further preferred. A buck converter circuit is herein also understood to be a voltage step-down converter, a current step-up converter, a chopper, a direct converter and the like, or any type of switched-mode power supply. This circuit can achieve both amplitude modulation and pulse-width modulation with a minimal number of electronic components. Amplitude modulation is possible with such a circuit by adjusting the LED current using, for example, hysteresis control resulting in a current wave shape. Pulse-width modulation may be achieved by switching the buck converter (switched-mode power supply) on and off, as required by the pulse-width modulation pattern which preferably has a low frequency. Any other switching power supply may be used as well.

Another aspect of the invention is a lighting device comprising a solid-state lighting unit, an acquisition unit arranged to determine a target brightness level of at least one solid-state lighting unit, a determination unit arranged to determine a reference driving current amplitude for obtaining the target brightness level, and a driving unit arranged to determine if the reference driving current amplitude is smaller than or equal to the optimum driving current amplitude and to drive the solid-state lighting unit with a pulse-width modulated optimum driving current amplitude when the reference driving current amplitude is smaller than or equal to the optimum driving current amplitude to obtain the target brightness level.

A further aspect of the invention is a system comprising at least two lighting devices, as previously described. The two lighting devices are driven by a driving unit in accordance with a method as previously described. This system ensures operation of solid-state lighting systems with more than one solid-state lighting source. It may provide adaptation of the overall brightness level of the lamps to the ambient light. Furthermore, it is possible to control the brightness level of single solid-state lighting units in order to adjust the lamp color and overall brightness.

Another aspect of the invention is a computer program product tangibly embodied in a record carrier, the computer program product comprising instructions which, when executed, cause at least one processor to perform the steps of: acquiring a target brightness level of at least one solid-state lighting unit, determining a reference driving current amplitude for obtaining the target brightness level, and driving the solid-state lighting unit with a pulse-width modulated optimum driving current amplitude when the reference driving current amplitude is smaller than or equal to the optimum driving current amplitude to obtain the target brightness level.

These aspects of the invention lead to an optimum luminous efficacy and efficiency at a given brightness level, and to driving the solid-state lighting unit with the reference driving current amplitude when the reference driving current amplitude is larger than the optimum driving current amplitude.

These and other aspects of the invention are apparent from and will be elucidated with reference to the embodiments described hereinafter.

### BRIEF DESCRIPTION OF THE DRAWINGS

In the drawings:

FIG. 1 shows a graph illustrating the relative luminous flux, the electric input power, and the luminous efficacy of a solid-state lighting device;

FIG. 2 shows an embodiment of a system according to the invention:

FIG. 3 is a flowchart illustrating the operation of a lighting unit according to the invention;

FIG. 4 shows an embodiment of a driving circuit;

FIG. 5 is a chart illustrating the driving current amplitude modulation;

FIG. 6 is a further chart illustrating the driving current pulse-width modulation.

### DESCRIPTION OF EMBODIMENTS

The present invention ensures an increase of the luminous efficacy for solid-state light sources, even at low brightness levels. The use of amplitude modulation to dim the brightness level of the solid-state light sources is suggested in monochrome lamps as well as in multi-color lamps, such as RGB LED lamps. This amplitude modulation is applied until the luminous efficacy is maximum. It is further proposed to keep the current amplitude at this value and use pulse-width modulation for dimming the brightness level to lower values. Using the inventive method allows dimming of solid-state lighting units with an optimized luminous efficacy in both monochrome and colored solid-state light sources.

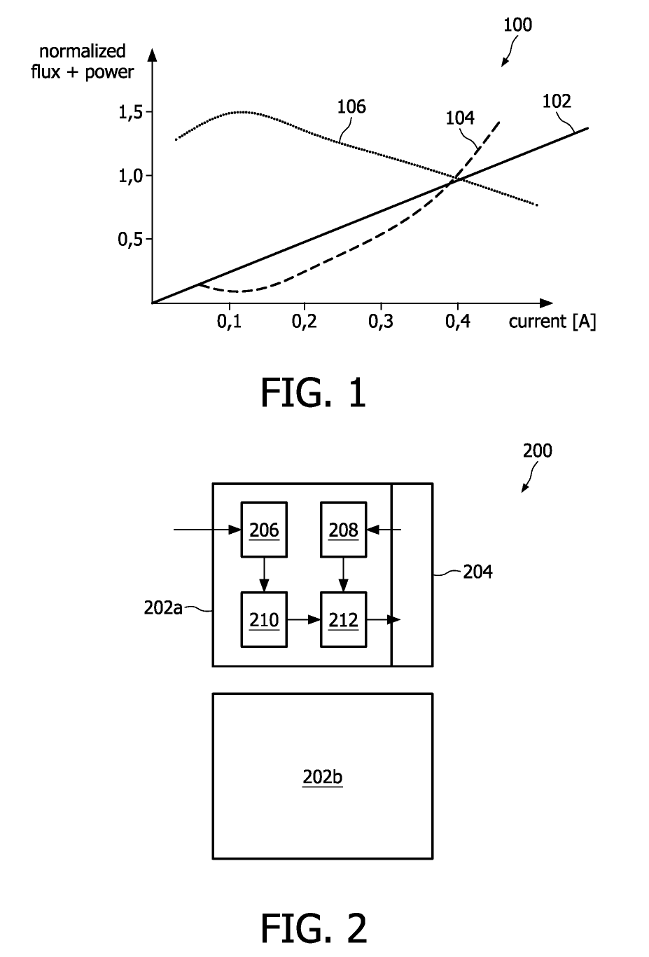

The method and device according to the invention utilize the fact that the luminous efficacy and the efficiency of the luminous flux of a solid-state lighting unit depends on the driving power and the luminous flux of the lighting unit. FIG. 1 is a chart 100 illustrating the dependency between input power 104, luminous flux 102, and efficiency 106, which is a function of the relation between the luminous flux 102 and the input power 104. As can be seen in chart 100, the luminous flux 102 increases with an increasing input power 104. This accounts for increasing the total brightness level of a solid-state lighting unit by increasing the input power 104. However, the efficiency of the solid-state lighting unit decreases with higher currents. As can be seen in chart 100, the luminous efficiency 106 has its maximum at about 0.1 A of the driving current. At this value, the efficiency is highest, resulting in the best ratio between input power and luminous flux. Usually, GaP 1W LEDs are operated at a current of 0.35 A for a maximum lumen output. Driving currents above this value are not allowed due to temperature constraints. For brightness level adjustment, it has been proposed that the current amplitude and thus the input power 104 should be reduced to 0.1 A. At this value, the luminous efficacy is maximum. If less lumen output is required, optimum luminous efficacy and efficiency at a given brightness level is provided when the solid-state lighting unit is driven with a reference driving current amplitude which is larger than the optimum driving current amplitude.

This gives rise to applying the method according to the present invention.

As illustrated in FIG. 2, the method according to the present invention can be carried out with a system 200. The system 200 may comprise a plurality of lighting devices 202a, 202b. The lighting devices 202 may comprise a solid-state lighting unit 204, which may be a LED or an OLED. The lighting devices 202 accommodate an acquisition unit 206 for determining a target brightness level of at least one solid-state lighting unit, a determination unit 208 for determining an optimum driving current amplitude of the LED 204, a determination unit 210 for determining a reference driving current amplitude for obtaining the target brightness level, and a driving unit 212 for driving the solid-state lighting unit 204 with the appropriate driving current, which may be amplitude modulated and pulse-width modulated. The acquisition unit 206 has an input port for receiving a target brightness level value, which may be supplied from a driving circuit driving the system 200 in order to obtain certain brightness levels and colors of the system 200. The determination unit 208 may receive values from the solid-state lighting unit 204 so as to obtain the optimum driving current amplitude. Alternatively, a user may also input the values for obtaining the driving current amplitude to determination unit 208. Furthermore, it may be possible to store these values in a look-up table in determination unit 208. Determination unit 208 may carry out tests on solid-state lighting unit 204 for obtaining the optimum driving current value. Driving unit 212 may drive the solid-state lighting unit 204 with the appropriate voltage and driving currents, using amplitude modulation and pulse-width modulation, as will be described further below.

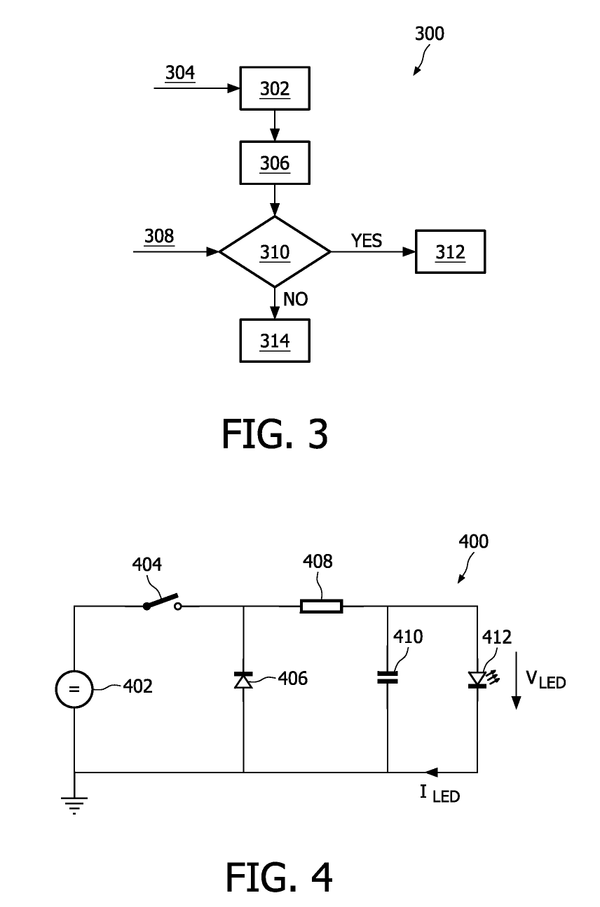

FIG. 3 is a flowchart 300 for operating a lighting device 202.

A target brightness level is input (304) to acquisition unit 206. Acquisition unit 206 forwards the acquired target brightness level to determination unit 210, within which a reference driving current amplitude for obtaining the target brightness level is determined (302). Determination of the reference driving current amplitude (302) is a conversion from the target brightness level to a continuous current amplitude required for obtaining this target brightness level. This calculation can be done by using the relation between the luminous flux 102 and the input power 104. The luminous flux 102 may be used for obtaining the required input power from a target brightness level and thus the required continuous current amplitude, i.e. the reference driving current amplitude.

In step 306, determination unit 210 calculates, from chart 100, the continuous current amplitude I_{CON}, which is the reference driving current amplitude.

The reference driving current amplitude I_{CON} is processed in step 310. In step 310, an optimum driving current amplitude is received (308) from determination unit 208 in driving unit 212. Driving unit 212 checks whether the reference driving current amplitude is larger than the received optimum driving current amplitude.

If driving unit 212 determines that the reference driving current amplitude is larger than the optimum driving current amplitude, driving unit 212 drives, in step 312, the solid-state lighting unit 204 with a driving current which is equal to the reference driving current amplitude. The reference driving current amplitude is preferably applied to the sold-state lighting unit 204 by using current amplitude modulation.

If the reference driving current amplitude is smaller than the optimum driving current amplitude, driving unit 112 drives solid-state lighting unit 204 in step 314 with a driving current which is equal to the optimum driving current. However, as this optimum driving current amplitude is larger than the reference driving current amplitude, the solid-state lighting unit 204 will provide a brightness level which is higher than the target brightness level. In step 314, the current applied to the solid-state lighting unit 204 is therefore pulse-width modulated. This pulse-width modulation accounts for lowering the brightness level as compared to applying a continuous current amplitude which is equal to the optimum continuous current amplitude. The duty cycle of the pulse-width modulation is calculated in driving unit 212 for the ratio between the reference driving current amplitude and the optimum driving current amplitude. The smaller the reference driving current amplitude as compared to the optimum driving current amplitude, the smaller the duty cycles, so that the brightness level is further reduced.

The operation of the driving unit 212 may be provided by a buck converter as illustrated in FIG. 4. The buck converter 400 comprises a voltage source 402, a switch 404, a diode 406, an inductance 408, a capacitor 410, and a LED 412. A buck converter 400 is a switched-mode power supply which can realize both amplitude modulation and pulse-width modulation. Amplitude modulation is possible by adjusting the LED current I_{LED} using hysteresis control of the circuit 400. Pulse-width modulation is obtained by switching the switched-mode power supply with switch 404 on and off, as required by the calculated duty cycle. The pulse-width modulated pattern results in a current shape as illustrated in FIG. 6.

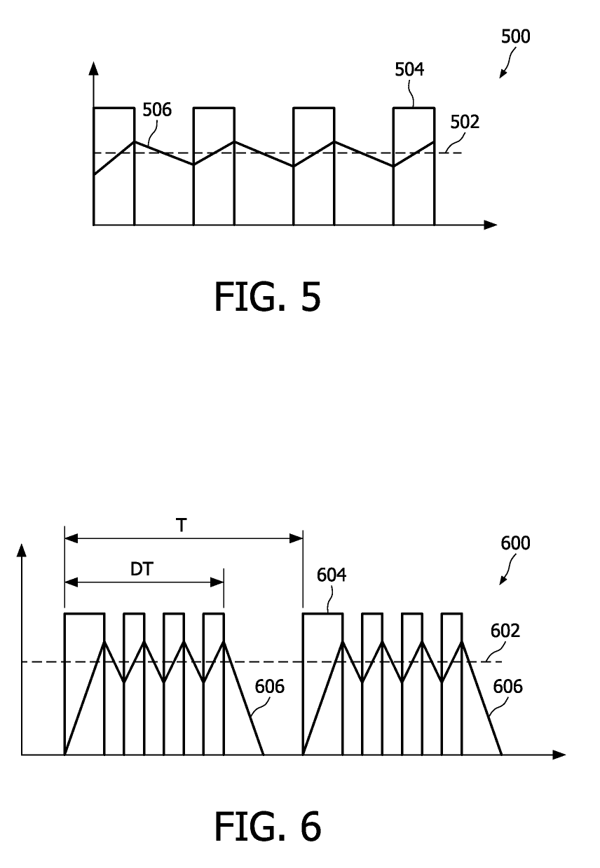

FIG. 5 is a chart 500 showing the continuous driving current amplitude 502, the control signal 504 applied to switch 404 for switching circuit 400 on and off, and the current I_{LED} 506 within the LED 412. The control signal 504 originates from a hysteresis control which ensures that the current I_{LED} 506 stays close to the continuous driving current amplitude 502. In the illustrated example, the duty cycle is 1 and the continuous driving current amplitude 502 equals the calculated reference current amplitude for obtaining the required brightness level. As can be seen, the current I_{LED} 506 oscillates around the continuous driving current amplitude 502.

FIG. 6 is a chart 600 showing a continuous driving current 602, a control signal 604 applied to switch 404, and a current I_{LED} 606 in LED 412. In the illustrated example, the continuous driving current 602 is set to the optimum driving current amplitude. This, however, leads to a brightness level which is higher than the target brightness level. For this reason, the control signal 604 is pulse-width modulated. The pulse-width modulation provides a duty cycle D within a period T which is the relation between the reference driving current amplitude and the optimum driving current amplitude. By providing pulse-width modulation of the control signal, the brightness level of the LED may be reduced in accordance with the value of the duty cycle. A driving current 606 oscillates around the optimum driving current amplitude 602. Superimposed on this pulse-width modulation pattern is switching of the control signal 604 which originates from a hysteresis control ensuring that the current I_{LED} 606 stays close to the continuous driving current amplitude 602.

The present invention ensures dimming of solid-state lighting units with an increased efficiency by using information about the luminous efficacy of the solid-state lighting units.

While fundamental novel features of the invention as applied to a preferred embodiment have been shown and described, it will be understood that various omissions, substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is therefore intended to be limited only as indicated by the scope of the appending claims. It should also be recognized that any reference sign shall not be construed as limiting the scope of the claims.

1. A method of operating a lighting device, the method comprising the steps of:
(a) acquiring a target brightness level of at least one solid-state lighting unit,
(b) determining a reference driving current amplitude for obtaining the target brightness level and an optimum driving current amplitude; and
(c) driving the solid-state lighting unit with a pulse-width modulated optimum driving current amplitude when the reference driving current amplitude does not exceed the optimum driving current amplitude to obtain the target brightness level.

2. The method of claim 1, wherein the optimum driving current amplitude is determined at least partially based on the driving current at which the solid-state lighting unit has a maximum efficiency.

3. The method of claim 2, wherein the maximum efficiency of the solid-state lighting unit is a maximum value of the ratio between the luminous flux and the input power of the solid-state lighting unit.

4. The method of claim 1, wherein the optimum driving current depends on the properties of the solid-state lighting unit material.

5. The method of claim 1, further comprising the step of driving the solid-state lighting unit with the reference driving current amplitude when the reference driving current amplitude is larger than the optimum driving current amplitude to obtain the target brightness level.

6. The method of claim 1, further comprising the step of driving the solid-state lighting unit with an amplitude-modulated driving current at least when the reference driving current amplitude is larger than the optimum driving current amplitude to obtain the target brightness level.

7. The method of claim 1, further comprising the step of determining the duty cycle of the pulse-width modulated optimum driving current amplitude at least partially based on the ratio between the reference driving current amplitude and the optimum driving current amplitude.

8. The method of claim 1, further comprising the step of driving the solid-state lighting unit with a buck converter circuit.

9. A lighting device, comprising:
(a) a solid-state lighting unit,
(b) an acquisition unit for determining a target brightness level of at least one solid-state lighting unit,
(c) a determination unit for determining a reference driving current amplitude for obtaining the target brightness level, and
(d) a driving unit configured to compare the reference driving current amplitude and the optimum driving current amplitude and to drive the solid-state lighting unit with a pulse-width modulated optimum driving current amplitude when the reference driving current amplitude does not exceed the optimum driving current amplitude to obtain the target brightness level.

10. A system comprising at least two lighting devices as claimed in claim 9, and a driving unit arranged to drive each of the at least two lighting devices with a target brightness level in accordance with a method as claimed in claim 1.

11. A computer program product tangibly embodied in a record carrier, the computer program product comprising instructions which, when executed, cause at least one processor to perform the steps of: acquiring a target brightness level of at least one solid-state lighting unit, determining a reference driving current amplitude for obtaining the target brightness level and an optimum driving current amplitude; and driving the solid-state lighting unit with a pulse-width modulated optimum driving current amplitude when the reference driving current amplitude is smaller than or equal to does not exceed the optimum driving current amplitude to obtain the target brightness level.
